(19) United States
(12) Patent Application Publication
(10) Pub. No.: US 2025/0372988 A1
(43) Pub. Date: Dec. 4, 2025

(54) LOW VOLTAGE CABLE HARNESS

(71) Applicant: Aaron Escobar, San Antonio, TX (US)

(72) Inventor: Aaron Escobar, San Antonio, TX (US)

(21) Appl. No.: 19/222,617

(22) Filed: May 29, 2025

Related U.S. Application Data
(60) Provisional application No. 63/653,172, filed on May 29, 2024.

(51) Int. Cl. H02G 3/00; H01B 7/00; H01B 7/18; H01B 13/012

(52) U.S. Cl. CPC H02G 3/263; H01B 7/0045; H01B 7/1815; H01B 13/01209; H01B 13/01263

(57) ABSTRACT

A pre-assembled low voltage wiring harness is configured for being installed in a building having framing. The wiring harness includes an exterior sheath having a trunk portion and a plurality of branch portions extending off the trunk portion. The wiring harness further includes a plurality of low voltage cables bundled inside the exterior sheath, and a plurality of attachment members coupled to the exterior sheath at a respective plurality of fixed, predetermined locations along a length of the exterior sheath. Each one of the attachment members includes a flexible strap, an attachment connector configured for removably attaching to the framing of the building, and an attachment marker for indicating an intended attachment location. The attachment connector may be a carabiner, a soft shackle, a hook, a snap hook, a clip, or a similar connector that does not require any tools for installation so that the wiring harness is easily installed.

### CROSS-REFERENCE TO RELATED APPLICATIONS

This application claims priority to U.S. Provisional Patent Application No. 63/653,172 filed on May 29, 2024, entitled “Low Voltage Cable Harness,” the contents of which are incorporated herein by reference.

### BACKGROUND

### Field of the Art

The present disclosure is related to the field of commercial and residential construction, focusing on innovations in low-voltage wiring systems for efficient installation in building structures.

### Discussion of the State of the Art

The field of Information Technology (IT) infrastructure, specifically in the context of commercial and residential building projects, is fraught with cost uncertainties and unpredictable timelines. A significant contributor to this problem is the installation of low-voltage cables, a task often outsourced to IT contractors. This process can become complex and time-consuming due to the specific knowledge and specialized tools required for installation. Moreover, the labor costs associated with this task can vary significantly, introducing financial unpredictability into building projects.

The installation of low-voltage cables is an important component of IT infrastructure, with applications ranging from data centers to residential buildings. However, the current process of installation is far from efficient. It is not uncommon for projects to experience delays and cost overruns due to the complexities involved in cable installation. This not only impacts the overall project timeline but also adds to the financial burden of the project.

In an attempt to address these challenges, some solutions have focused on loosely bundling cables, a practice commonly seen in structured cabling for data centers. However, these solutions fail to adequately streamline the installation process, which is still labor-intensive and time-consuming. Furthermore, these solutions do not eliminate the need for specialized knowledge or tools, thus failing to significantly reduce labor costs or installation time.

In summary, the current methods and systems for installing low-voltage cables in IT infrastructure projects are fraught with problems. They introduce cost uncertainty, are time-consuming, require specialized knowledge and tools, and fail to provide a streamlined process for installation. Despite attempts to address these issues, existing solutions have proven to be suboptimal, leaving a significant gap in the field.

### SUMMARY

The present invention is an innovative apparatus for installing low-voltage wiring, such as ethernet cables, in a structure. This apparatus comprises a pre-engineered harness that securely bundles a plurality of low-voltage cables. The harness is designed to be easily mounted to a structure's frame, such as joists, through the use of integrated anchoring members like straps or webbing fitted with carabiners or similar attachments.

This cable harness effectively addresses the challenges faced by previous solutions. The pre-engineered harness is designed with structural data and end-user requirements in mind, allowing for a streamlined installation process. It can be branched to match a site's layout and includes a slack length of cable, making the harness salvageable. The harness may include exterior sheathing for added protection and durability of the low-voltage cables bundled inside the sheathing.

The benefits of this invention are manifold. The exterior sheathing enhances safety by shielding the wires from pests or other environmental hazards. The mounting system allows the harness to be removably coupled to the frame of the structure, and requires no tools, making the installation process much simpler and reducing the need for specialized contractors. This, in turn, reduces lead time and costs associated with the installation. Furthermore, the harness can be easily removed and reinstalled, providing additional flexibility.

The wiring harness includes an exterior sheath encasing a plurality of low-voltable cables, attachment members, attachment markers, and drop point markers. The harness may also include a structural core, such as an aluminum rod, for added strength. The exterior sheath may comprise PEX sheathing for additional protection. The harness in accordance with the present invention represents a significant advancement in the field of low-voltage cable installation, delivering enhanced efficiency, safety, and cost-effectiveness.

In one example, the invention is a pre-assembled low voltage wiring harness configured for being installed in a building having framing. The wiring harness includes an exterior sheath having a trunk portion and a plurality of branch portions extending off the trunk portion. Each one of the branch portions may include a drop point marker for indicating an intended drop location. A material of the exterior sheath may be aramid, carbon infused nylon monofilament, PET, PEX, nylon polyamide monofilament, fiberglass filament in acrylic resin, BoPET polyester film based wrap, silver plated copper braid, or any combination thereof. The wiring harness further includes a plurality of low voltage cables bundled inside the exterior sheath. Each one of the low voltage cables may have a length that includes a measured length plus a slack length. The harness may further include a structural core disposed within a portion of the exterior sheath. The structural core may include an aluminum rod or a carbon fiber rod. The harness further includes a plurality of attachment members coupled to the exterior sheath at a respective plurality of fixed, predetermined locations along a length of the exterior sheath. Each one of the attachment members includes a flexible strap, an attachment connector configured for removably attaching to the framing of the building, and an attachment marker for indicating an intended attachment location. The attachment connector may be a carabiner, a soft shackle, a hook, a snap hook, and/or a clip. The flexible strap of each one of the attachment members is fixedly coupled to the exterior sheath in a corresponding one of the fixed, predetermined locations.

In another example, the invention is a method of making a pre-assembled low voltage wiring harness. The method includes determining a layout of a wiring harness by analyzing electrical specifications and building layout specifications, and cutting a plurality of low voltage cables to predetermined lengths. The predetermined lengths of the low voltage cables may include a measured length plus a slack length of each one of the low voltage cables. The method further includes bundling the plurality of cables within an exterior sheath, integrating a plurality of attachment members with the exterior sheath at a respective plurality of fixed locations along a length of the exterior sheath, and adding a plurality of attachment markers and a plurality of drop point markers to the wiring harness. Each one of the attachment members may include a connector (e.g., a carabiner) configured for removably attaching the wiring harness to a frame of a building. The method may further include positioning a structural core within the exterior sheath. The structural core may be an aluminum rod or a carbon fiber rod.

In yet another example, the invention is a method of installing a pre-assembled low voltage wiring harness. The method includes receiving the pre-assembled low voltage wiring harness and associated installation instructions at a building site that comprises building framing. The pre-assembled low voltage wiring harness includes a plurality of attachment members at fixed locations along the wiring harness. The method further includes consulting the installation instructions to identify intended attachment locations on the building framing for each one of the attachment members. Each one of the attachment members is labeled with an attachment marker that corresponds to one of the intended attachment locations. The method further includes installing the wiring harness by attaching the attachment members to the corresponding attachment locations on the building framing. The wiring harness may further include a plurality of drop point markers associated with a plurality of branch portions of the wiring harness. The method may further include consulting the installation instructions to identify intended drop point locations within the building framing, and dropping the plurality of branch portions at the drop point locations indicated by the drop point markers.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates a portion of a pre-assembled low voltage wiring harness, in accordance with an aspect of the present invention.

FIGS. 1B and 1C are cross-sectional views of a wiring harness that does not include a structural core, and a wiring harness that does include a structural core, respectively, in accordance with aspects of the present invention.

FIGS. 1D and 1E illustrate portions of a pre-assembled low voltage wiring harness, in accordance with an aspect of the present invention.

FIG. 2 illustrates an attachment member attached to an exterior sheath of the wiring harness, in accordance with an aspect of the present invention.

FIG. 3 is a diagram that illustrates the layout of a wiring harness and includes labeled attachment points and drop points, in accordance with an aspect of the present invention.

FIG. 4 is a flow chart of a method of making a pre-assembled low voltage wiring harness, in accordance with an aspect of the present invention.

FIG. 5 is a flow chart of a method of installing a pre-assembled low voltage wiring harness, in accordance with an aspect of the present invention.

FIGS. 6A-6D are diagrams that illustrate a wiring harness system that includes three separate wiring harnesses, in accordance with an aspect of the present invention.

### DETAILED DESCRIPTION

The present invention is for a low-voltage wiring harness designed to streamline the installation and organization of low-voltage wiring within residential or commercial buildings. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

The present invention is for a pre-assembled low voltage wiring harness, designed to facilitate the installation of low-voltage wiring within a structure, such as a commercial or residential building. By pre-fabricating the wiring harness offsite, installation time is greatly decreased since the installer has only one harness to install rather than a plurality of individual low voltage cables. The decrease in installation time is significant, especially for projects involving extensive networks or wiring. Further, the cost of installation may be decreased since installing the pre-assembled wiring harness does not require any specialized skills or expertise. The pre-assembled harness offers a user-friendly and cost-effective solution by bundling the cables in an organized manner, simplifying installation, and enhancing the potential for salvageability.

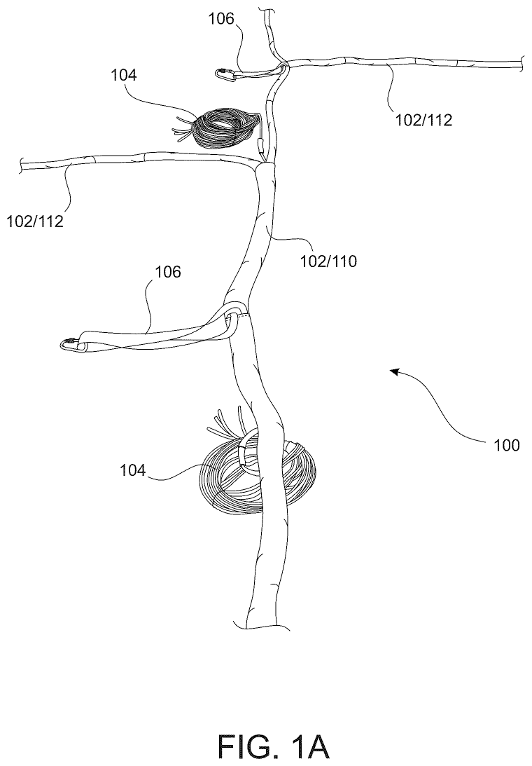

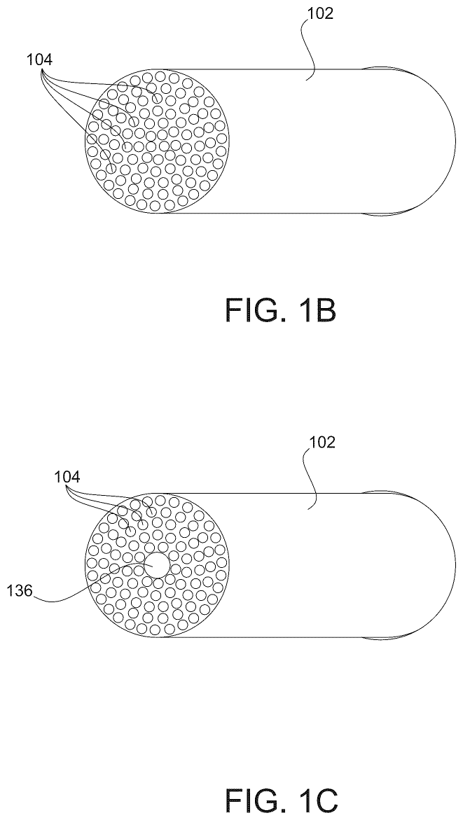

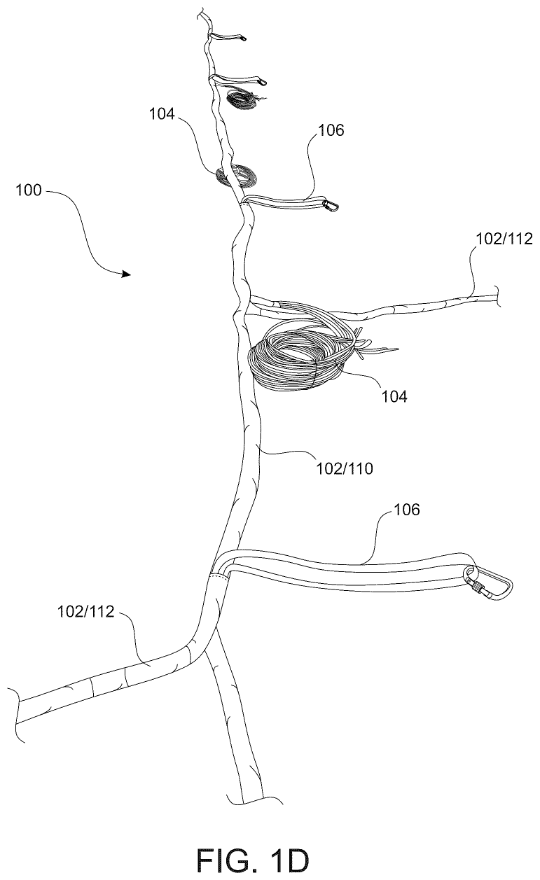

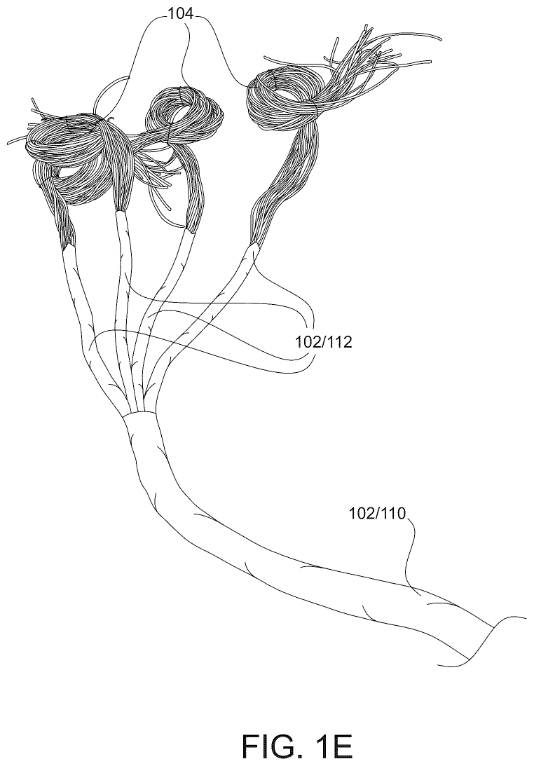

As shown in FIGS. 1A-1E, a wiring harness 100 configured for being installed in a structure, such as a commercial or residential building, includes an exterior sheath 102, a plurality of low voltage cables 104 bundled within the sheath 102, and attachment members 106 for anchoring the harness 100 to the frame of the structure. As shown in FIGS. 1A and 1C, the exterior sheath 102 includes a main trunk portion 110 and a plurality of branch portions 112. The exterior sheath 102 may be resistant to cutting, abrasion, rodent damage, high heat, water damage, and/or the like, to provide enhanced protection for the low-voltage cables 104 housed within the sheath 102. The exterior sheath 102 may be made of aramid, carbon infused nylon monofilament, PET, PEX, nylon polyamide monofilament, fiberglass filament in acrylic resin, BoPET polyester film based wrap, silver plated copper braid, and/or the like, and/or any combination thereof.

The wiring harness 100 is deployed by the user during the framing stage of construction. Following building blueprints and/or wiring diagrams, the user runs the harness 100 according to the structure's layout and power demands. The user secures the harness 100 to the building frame, such as joists, using the integrated anchoring members 106. When the drywall is placed, the user can conveniently connect the harness 100 to the designated wall ports, enabling the low-voltage wiring system to be easily integrated into the structure.

The harness 100 serves as a conduit for a multitude of low-voltage cables 104, such as ethernet cables or speaker wires. In one example, the harness 100 may contain between 15 and 120 low-voltage cables 104, although this number can vary depending on the specific requirements of the structure and the power demands. The harness 100 is designed to carry the entire low-voltage cable capacity for the structure, providing a centralized and organized means of managing the cables 104. In another example, two or more wiring harnesses are used in a structure, with each wiring harness dedicated to a particular function, such as main network, internet and wi-fi networks, IP telephone networks, indoor and/or outdoor lighting, access control systems, automation control systems, kitchen display systems, energy management systems, digital menu board systems, point-of-sale systems, security, audio, or the like. In this manner, each wiring harness may be detached and uninstalled for repairs, upgrades, or replacement.

In terms of configuration, the harness 100 may be designed such that a group of cables can branch off from the main cluster of cables. This allows for flexibility in meeting the unique structural requirements and power demands of the building. Additionally, the harness 100 may include a slack length of low-voltage cable, providing the potential for the harness to be salvageable.

As shown in FIG. 1C, the wiring harness 100 may optionally include a structural core 136 integrated within the harness 100 for added strength and stability. The structural core 136 may be an aluminum rod, carbon fiber rod, or other similar lightweight, rigid member. The structural core 136 may be used to add some rigidity and strength to sections of the harness 100. The core 136 may provide additional stability to the harness, ensuring it maintains its shape and integrity during installation and use, without adding too much additional weight.

The attachment members 106 serve as anchoring devices, securing the harness 100 to the framework of a structure, such as a joist. Given that low-voltage cable is often run across what will eventually become the ceiling of the rooms within a structure, the attachment members 106 help prevent the harness 100 from falling or sagging due to gravity.

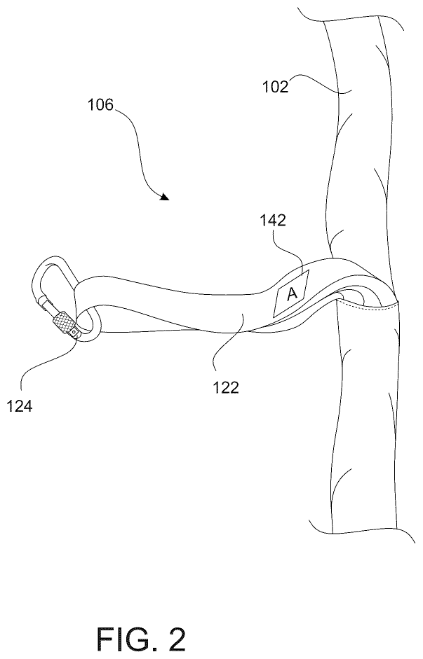

For added structural integrity and durability, the attachment member 106 is a tether that can be interwoven among the low-voltage cables 104 that comprise the harness 100. As shown in FIG. 2, the attachment member 106 is fixedly attached to a desired location on the exterior sheath 102. In one example, the attachment member 106 is threaded through the filaments of the exterior sheath 102, but the invention is not limited to this arrangement. The attachment member 106 can be fixedly attached to the sheath 102 in any manner that prevents the attachment member 106 from moving axially relative to the sheath 102 such that the attachment member 106 is in a fixed position relative to the sheath 102. The attachment member 106 may be anchored to the harness 100 at branches, where a group of cables diverge from the main low-voltage cable cluster.

The attachment member 106 may include a composite load-bearing strap 122 and connector 124, designed to withstand a tensile strength exceeding 200 pounds. This strength allows the attachment member 106 to securely hold the harness 100, even when it is laden with a multitude of low-voltage cables 104. The strap 122 may be flexible to allow for some margin of error in the attachment location. In one example, the flexible strap 122 may be webbing made of nylon, polyester, canvas, or the like. However, the invention is not limited to these materials and the flexible strap 122 may be made of any flexible, durable material. The connector 124 may be configured for being removably attached to the frame of the structure without requiring any tools for installation. The attachment connector 124 is depicted as a carabiner, but may alternatively be a snap hook, soft shackle, clip, hook, hook and loop closure, or the like. Notably, the attachment connector 124 is configured for attaching to the frame of the structure without requiring any tools and without attaching a receptacle or mating connector to the frame of the structure. In this manner, the wiring harness 100 is easily installed and can easily be removed for repairs, upgrades, or replacement.

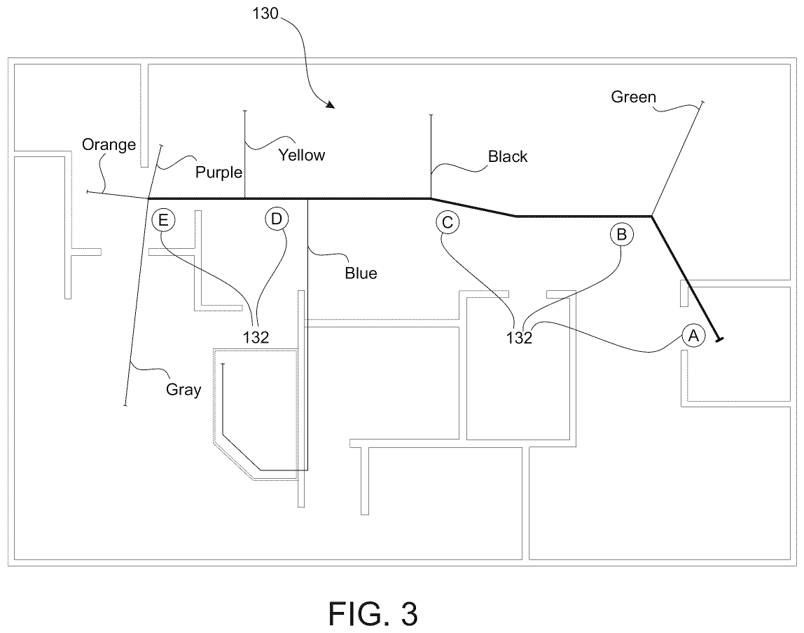

The attachment member 106 may further include an attachment marker 142 for indicating an intended attachment location. The attachment marker 142 may include an alphanumeric character, symbol, color, or the like. The installation instructions for the wiring harness 100 would include a diagram having a marking corresponding to the attachment marker 142 for showing where the attachment member 106 should be attached to the structure. Each attachment member 106 coupled to the harness 100 includes a unique attachment marker that corresponds to an intended attachment location indicated on the diagram. For example, FIG. 3 is an installation diagram 130 where each of the intended attachment locations 132 are indicated with a letter. The attachment members 106 on the harness 100 would be marked with corresponding letters to indicate which intended attachment location 132 each attachment member 106 should be coupled to. This is an advantageous feature of the wiring harness 100 because it allows the wiring harness 100 to be installed without requiring any special skills or expertise. The attachment markers on the attachment members 106 simplify the installation process by identifying the pre-planned points where the harness 100 should be tethered to the structure's frame. These markers correspond with each respective attachment member 106, facilitating easy matching and reducing complexity during installation. Although the attachment marker 142 is depicted as being a label attached to the strap 122 of the attachment member 106, the invention is not limited to this configuration. The attachment marker may alternatively be coupled to the connector 124 or to the exterior sheath 102 in the vicinity of the attachment member 106. Further, the attachment marker may be coupled to the attachment member by adhesive, snaps, hook and loop closure, or any other similar coupling mechanism. Still further, the attachment marker may be the color of the strap 122 such that each attachment member 106 has a different color strap 122 and the color of the strap 122 coordinates with the color of the intended attachment location on the diagram.

Similarly, each branch portion of the harness 100 may include a drop point marker for indicating a drop point location for that branch. The drop point marker on the harness 100 corresponds to a marking on the installation instructions diagram to indicate where that branch should drop down. For example, as shown in FIG. 3, each drop point location on the installation diagram 130 is indicated with a color (e.g., purple, orange, yellow, black, grey, green, and blue)

The harness 100 is pre-engineered based on the specific structural specifications of a site, including blueprints and wiring diagrams, among other data. This pre-engineering process allows for the identification of specific drop points for the harness 100, which are then marked using the drop point markers. In an exemplary embodiment, the harness 100 comprises small groupings of cables, or “branches,” each of which has a specific drop point as indicated by the corresponding drop point marker on the harness 100 and the corresponding drop point indicator on the installation instructions. The drop point indicators are shown as being colors in FIG. 3, but may alternatively be alphanumeric characters, symbols, shapes, or the like.

The manufacturing process of the harness is a multi-step procedure that begins with providing a blueprint, end-user specifications, and structure data to a computer software system. The system then compiles measurement data, potentially using lasers or time-domain reflectometry, to determine the base cable length and the slack length. Following this, a bundle of low-voltage cables 104 is prepared. The composite bundle of cables 104 is then wrapped with the exterior sheathing 102, and the attachment members 106 are fixedly coupled to the sheathing 102 marked to correspond with attachment points, ensuring accurate and efficient installation.

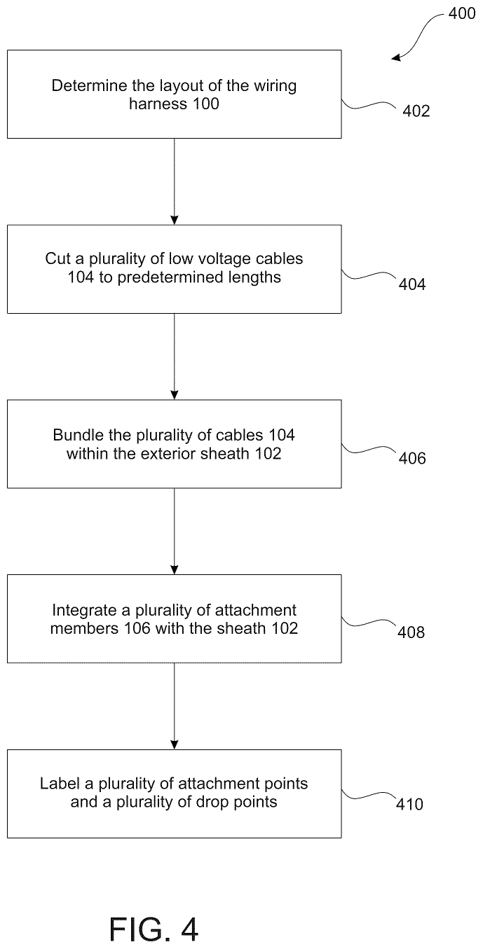

Referring to FIG. 4, a method 400 of making the pre-assembled low voltage wiring harness 100 will be described in more detail. First, in step 402, the layout of the wiring harness 100 is determined by analyzing electrical specifications and building layout specifications. Next, in step 404, a plurality of low voltage cables 104 are cut to predetermined lengths. The predetermined lengths of the cables 104 may be based on measured lengths plus slack lengths. Next, in step 406, the plurality of cables 104 are bundled and secured within an exterior sheath 102. Optionally, the method 400 may include a step of positioning a structural core 136, such as an aluminum or carbon fiber rod, within the sheath 102 along with the cables 104. Next, in step 408, a plurality of attachment members 106 are integrated into the sheath 102 at a respective plurality of fixed locations along the sheath 102. As discussed above, the attachment members 106 include connectors 124, such as carabiners, for removably attaching the wiring harness to the frame of the building without requiring any tools. Finally, in step 410, a plurality of attachment markers and drop point markers are added to the wiring harness 100. After the method 400 is completed, the wiring harness 100 is ready to be packed and transported to the installation location or building site.

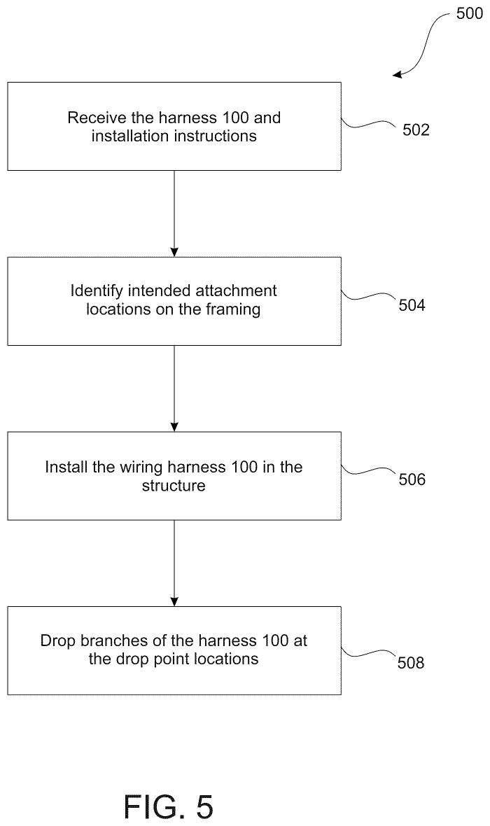

Referring to FIG. 5, a method 500 of installing the pre-assembled low voltage wiring harness 100 will be discussed. First, in step 502, the pre-assembled low voltage wiring harness 100 and associated installation instructions are received at a building site. The building site includes building framing that the wiring harness 100 can be attached to. There are a plurality of labeled attachment members 106 at fixed locations along the wiring harness 100. Next, in step 504, intended attachment locations are identified on the building framing by consulting the installation instructions. Each one of the attachment members 106 is labeled to correspond with one of the intended attachment locations. Next, in step 506, the wiring harness is installed by attaching the attachment members to the corresponding attachment locations on the building framing. Notably, the step of attaching the attachment members does not require any tools since the connectors 124 on the attachment members do not require any tools to operate. The method 500 may further include the step 508 of dropping branch portions of the harness at drop point locations as indicated by drop point markers on the harness 100. The drop point locations in the building are identified by consulting the diagram in the installation instructions and each drop point location is matched with one of the drop point markers on the harness 100.

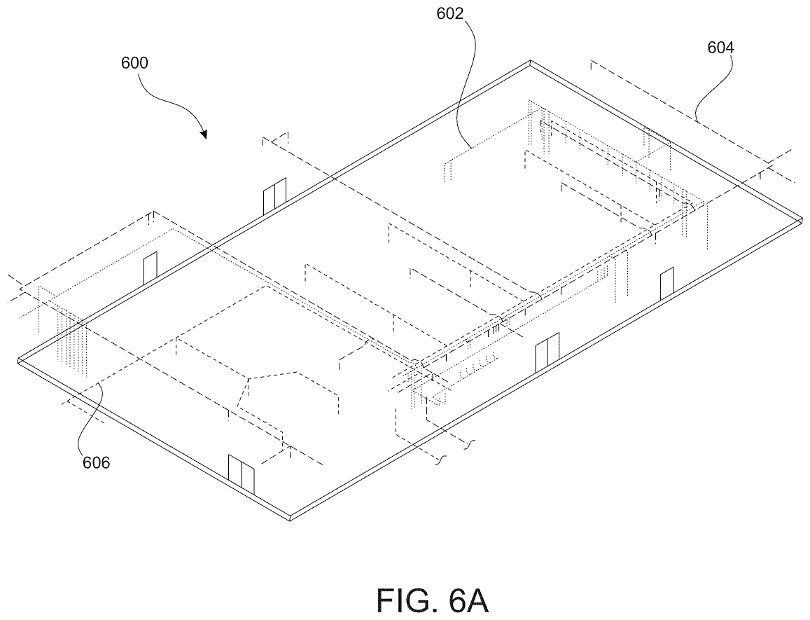

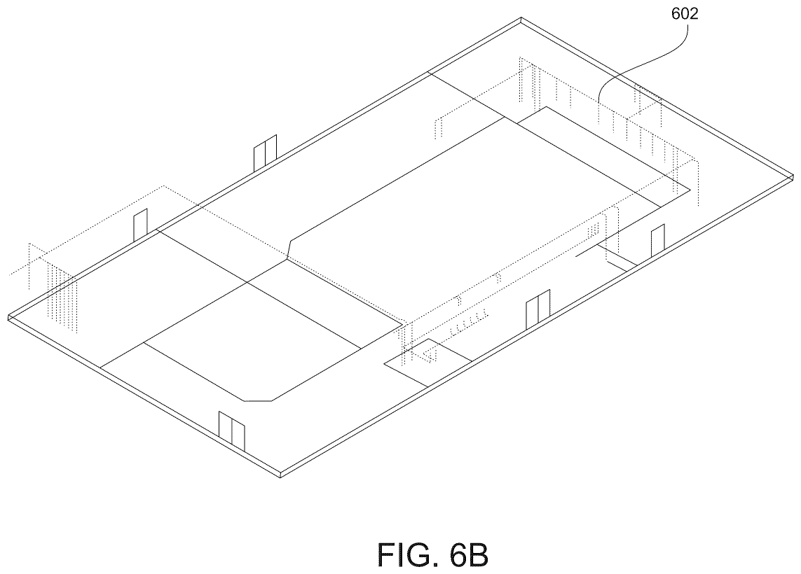

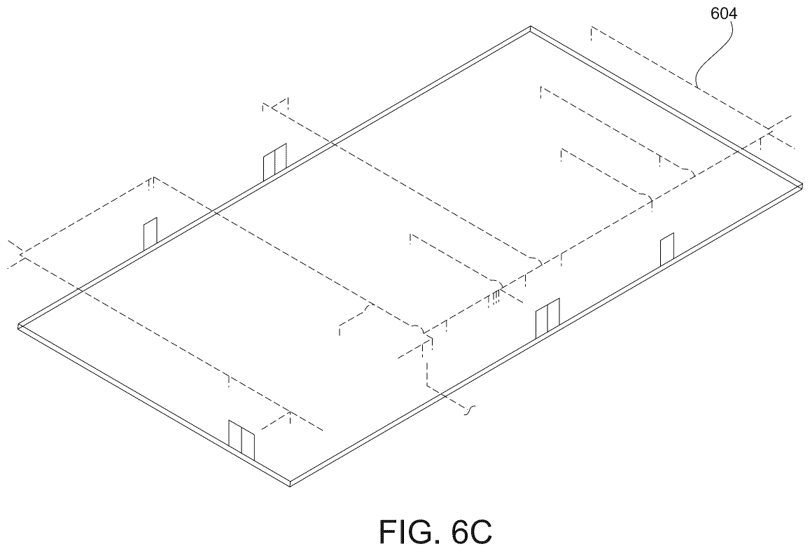

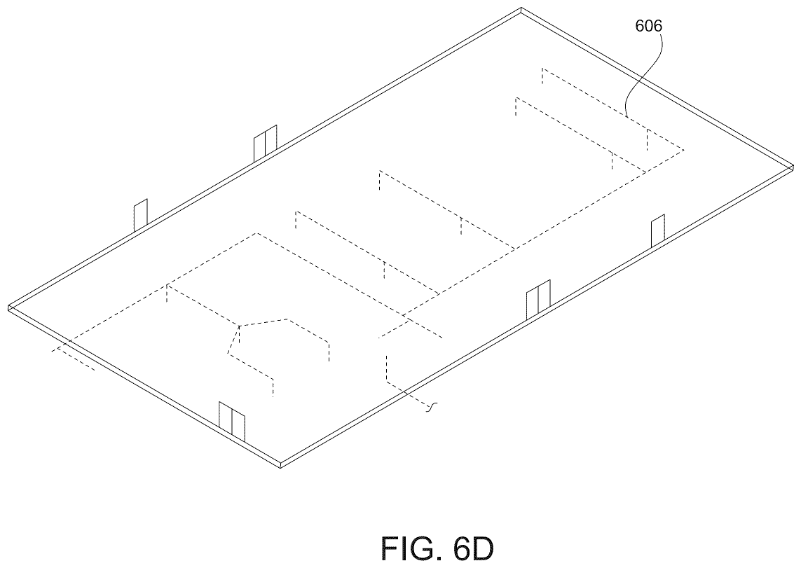

In one example, depicted in FIGS. 6A-6D, a method of installing includes installing multiple wiring harnesses. This system 600 including multiple harnesses is advantageous because each harness can be separately uninstalled for repairs, upgrades, replacement, maintenance, etc. The example shown in FIGS. 6A-6D includes three harnesses 602, 604, 606, but the system may alternatively include two harnesses or four or more harnesses. Each harness may be dedicated to a different function, such as main network, audio, and security. Additionally or alternatively, a separate, dedicated harness may be used for low voltage wiring of internet and wi-fi networks, IP telephone networks, indoor and/or outdoor lighting, access control systems, automation control systems, kitchen display systems, energy management systems, digital menu board systems, point-of-sale systems, or the like. Alternatively, rather than having a dedicated function, each separate harness may be dedicated to a different part of the building. FIG. 6A is a diagram depicting a layout that includes all three harnesses 602, 604, 606. FIG. 6B is a diagram depicting the layout of the first harness 602. FIG. 6C is a diagram depicting the layout of the second harness 604. FIG. 6D is a diagram depicting the layout of the third harness 606.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A pre-assembled low voltage wiring harness configured for being installed in a building having framing, the wiring harness comprising:
an exterior sheath comprising a trunk portion and a plurality of branch portions extending off the trunk portion;
a plurality of low voltage cables bundled inside the exterior sheath; and
a plurality of attachment members coupled to the exterior sheath at a respective plurality of fixed, predetermined locations along a length of the exterior sheath,
wherein each one of the attachment members comprises a flexible strap, an attachment connector configured for removably attaching to the framing of the building, and an attachment marker for indicating an intended attachment location.

2. The wiring harness of claim 1, wherein the attachment connector comprises at least one of: a carabiner, a soft shackle, a hook, a snap hook, and a clip.

3. The wiring harness of claim 1, wherein the attachment connector is a carabiner.

4. The wiring harness of claim 1, wherein the flexible strap of each one of the attachment members is fixedly coupled to the exterior sheath in a corresponding one of the fixed, predetermined locations.

5. The wiring harness of claim 1, further comprising a structural core disposed within a portion of the exterior sheath.

6. The wiring harness of claim 5, wherein the structural core comprises an aluminum rod or a carbon fiber rod.

7. The wiring harness of claim 1, wherein each one of the branch portions comprises a drop point marker for indicating an intended drop location.

8. The wiring harness of claim 1, wherein a material of the exterior sheath comprises aramid, carbon infused nylon monofilament, PET, PEX, nylon polyamide monofilament, fiberglass filament in acrylic resin, BoPET polyester film based wrap, silver plated copper braid, or any combination thereof.

9. The wiring harness of claim 1, wherein each one of the low voltage cables has a length that comprises a measured length plus a slack length.

10. A method of making a pre-assembled low voltage wiring harness comprises:
determining a layout of a wiring harness by analyzing electrical specifications and building layout specifications;
cutting a plurality of low voltage cables to predetermined lengths;
bundling the plurality of cables within an exterior sheath;
integrating a plurality of attachment members with the exterior sheath at a respective plurality of fixed locations along a length of the exterior sheath; and
adding a plurality of attachment markers and a plurality of drop point markers to the wiring harness.

11. The method of claim 10, wherein the predetermined lengths of the low voltage cables comprise a measured length plus a slack length of each one of the low voltage cables.

12. The method of claim 10, wherein each one of the attachment members comprises a connector configured for removably attaching the wiring harness to a frame of a building.

13. The method of claim 10, wherein each one of the attachment members comprises a carabiner.

14. The method of claim 10, further comprising positioning a structural core within the exterior sheath.

15. The method of claim 14, wherein the structural core is an aluminum rod or a carbon fiber rod.

16. A method of installing a pre-assembled low voltage wiring harness comprises:
receiving the pre-assembled low voltage wiring harness and associated installation instructions at a building site that comprises building framing, wherein the pre-assembled low voltage wiring harness comprises a plurality of attachment members at fixed locations along the wiring harness;
consulting the installation instructions to identify intended attachment locations on the building framing for each one of the attachment members, wherein each one of the attachment members is labeled with an attachment marker that corresponds to one of the intended attachment locations;
installing the wiring harness by attaching the attachment members to the corresponding attachment locations on the building framing.

17. The method of claim 16, wherein the wiring harness further comprises a plurality of drop point markers associated with a plurality of branch portions of the wiring harness, and the method further comprises:
consulting the installation instructions to identify intended drop point locations within the building framing; and
dropping the plurality of branch portions at the drop point locations indicated by the drop point markers.
